(19) United States
(12) Patent Application Publication
(10) Pub. No.: US 2024/0391781 A1
(43) Pub. Date: Nov. 28, 2024

(54) ACTIVATED CARBON BEADS WITH REDUCED DUST SPILLAGE

(71) Applicant: Manish JAIN, Pune, Maharashtra (IN)

(72) Inventors: Manish JAIN, Pune, Maharashtra (IN); Vivek Kumar JHA, Pune, Maharashtra (IN)

(21) Appl. No.: 18/700,274

(22) PCT Filed: Nov. 16, 2022
(86) PCT No.: PCT/IN2022/051007

§ 371 Date: Apr. 11, 2024

(30) Foreign Application Priority Data
Nov. 16, 2021 (IN) 202121052500
May 19, 2022 (IN) 202221028833

(51) Int. Cl. C01B 32/318; B01J 20/12; B01J 20/20; B01J 20/28; B01J 20/30

(52) U.S. Cl. CPC C01B 32/318; B01J 20/12; B01J 20/20; B01J 20/28004; B01J 20/28011; B01J 20/28019; B01J 20/2803; B01J 20/2805; B01J 20/3021; B01J 20/3078

(57) ABSTRACT

The present invention discloses activated carbon beads with reduced dust spillage, packaged in pervious canisters or sachets. The activated carbon beads are spherical in shape that allows to insert enough quantity of the activated carbon in the package. The spherical beads provide higher surface area to improve the adsorption performance and in turn reduce the dust spillage of the activated carbon from the package. The activated carbon beads are packaged in pervious canisters or sachets to adsorb contaminant gases emitting through food, pharmaceutical and nutraceutical products. The present invention also discloses activated carbon tablet with reduced dust spillage and having have high abrasive strength, surface area and adsorption capacity. composition that includes activated carbon powder, attapulgite clay, a binder and a lubricant.

### FIELD OF THE INVENTION

The present invention relates to activated carbon beads and more particularly to activated carbon beads and tablets with reduced dust spillage.

### BACKGROUND OF THE INVENTION

High levels of humidity in the atmosphere can cause some products to absorb the moisture from the atmosphere. If the pharmaceutical and nutraceutical products absorb moisture from the atmosphere, there is a high possibility of degradation of that products. As a result, the potency and nutritional value of that product is lost. Therefore, the pharmaceutical and nutraceutical products require protection from moisture, oxidation and contaminants to preserve their shelf life. Various desiccants have been used in the pharmaceutical and nutraceutical industries to preserve the quality of the packaged product and in turn increase the shelf life of the product. The widely used desiccants include silica gel, activated charcoal, calcium chloride, activated alumina, etc.

The US patent application U.S. Pat. No. 3,994,829A describes a method of production of activated carbon. The US patent U.S. Pat. No. 8,927,457B2 discloses a process of preparing spherical activated carbon particles using organic polymer spherules and improved synthesis steps. Thus, various methods of producing activated carbon are known in the art.

The US patent application U.S. Pat. No. 5,759,241A teaches a desiccant canister. The canister described in the prior art has pervious gas permeable disc shaped member at the end. The problem with the pervious canisters available in the art is spillage and leakage of dust from the canister containing activated charcoal particles.

Activated carbon has been extensively used for the adsorptive removal of contaminating gases. Thus, the activated carbon granules have been used to serve the purpose of adsorbing the contaminants in the form of moisture, unwanted gases or odorous substances. There is an unmet need of an odor removal desiccant for food products, pharmaceuticals, nutraceutical products, etc.

The activated carbon granules possess irregular size. As a result, their sharp edges break into powder and spill out of filter pouches and pervious canisters. The fine particles spillage through the available packaging media contaminates the pharmaceutical/nutraceutical product under contact. This imparts contamination in the direct contact food, medicines and nutraceuticals that is unfit for human consumption.

There is an unmet need of producing activated carbon beads embracing high abrasive strength and adsorption characteristics. There is a further need of producing activated carbon forms that restrain the dust spillage problem encountered by the food and drug industry. Further there is a need for an activated carbon composition capable of simultaneous removal of odor and moisture from pharmaceutical or nutraceutical products.

### SUMMARY OF THE INVENTION

The present invention discloses activated carbon beads having reduced dust spillage wherein the beads have a diameter in range of 0.3-2 mm. The present invention also discloses a process for preparation of the activated carbon beads wherein the steps are: (a) preparing activated carbon from coconut shells; (b) treating the carbon with polymer; (c) preparing beads of the carbon by precipitation, fluidized bed granulation or rotary granulation; (d) activating the carbon beads through drying, heating and/or calcination to remove the added biopolymer partially/completely: (e) rotational agitation of beads to separate any dust spillage followed by sieving the beads to obtain beads of desired sizes, specifically sizing 0.3-2 mm; and (f) packaging the beads into pervious canisters or pouches. The polymers used for treating the carbon are selected from natural polymers selected from biopolymers, protein polymers or synthetic biodegradable polymers or synthetic polymers selected from polymers based on vinyl, acrylic or methacrylic acids. The present invention also discloses an activated carbon tablet composition comprising: a) 50 to 80 g of Activated carbon powder; b) 10 to 40 g of Attapulgite clay; c) 5.5 to 10 g of a binder, and d) 0.75 to 2 g of a lubricant. In another embodiment, the tablet includes an additional desiccant selected from silica gel, molecular sieves 4A, molecular sieves 5A, molecular sieves 3A and molecular sieves 13X. The binder is polyvinyl alcohol and the lubricant is magnesium stearate. A process for preparing the activated carbon tablets includes the steps of: (a) adding attapulgite clay to the activated carbon powder in a ratio of 70:20; (b) adding the lubricant to the mixture of step (a); (c) dissolving binder in water by heating 80° C. for 20 minutes; (d) adding binder to the mixture formed in step (b); (e) preparing a slurry of the mixture of step (b) by adding water; (f) drying the slurry at 110° C. for 3-4 hours; (g) grinding the dried mixture to obtain powder followed by sieving and (h) making the tablets from the powder obtained in step (g) using a tablet press machine.

### BRIEF DESCRIPTION OF THE DRAWINGS

FIG. 1 shows the butane activity of activated carbon tablet of the present invention.

### DETAILED DESCRIPTION OF THE INVENTION

The present invention relates to activated carbon beads with reduced dust spillage. The present invention also relates to activated carbon beads having extensive fill density, high surface area and high wear resistance capacity in gas and odor adsorption applications. Further the present invention relates to activated carbon tablets, for adsorption of odor and moisture from pharmaceutical and nutraceutical products, that have high abrasive strength, surface area and adsorption characteristics.

The foregoing objects of the present invention are accomplished and the problems and shortcomings associated with the prior art, techniques and approaches are overcome by the present invention as described below in the preferred embodiments.

All materials used herein were commercially purchased as described herein or prepared from commercially purchased materials as described herein.

Although specific terms are used in the following description for sake of clarity, these terms are intended to refer only to particular structure of the invention selected for illustration in the drawings and are not intended to define or limit the scope of the invention.

References in the specification to “preferred embodiment” means that a particular feature, structure, characteristic, or function described in detail thereby omitting known constructions and functions for clear description of the present invention.

In one aspect, the present invention provides shaped activated carbon preferably spherical beads having extensive fill density, reduced dust spillage, high surface area and high wear resistance capacity in gas and odor adsorption applications.

In another aspect, the present invention provides a process for preparing the activated carbon beads.

In yet another aspect, the present invention provides activated carbon tablet composition having reduced dust spillage, high abrasive strength, surface area and adsorption characteristics.

In a further aspect, the present invention provides a composition of activated carbon tablets along with silica gel and various molecular sieves.

In accordance with a preferred embodiment, the activated carbon beads have high abrasive strength, surface area, adsorption characteristics and would restrain the dust spillage problem.

In this preferred embodiment, the activated carbon beads are spherical having a diameter in range of 0.3-2 mm. This allows to insert enough quantity of the activated carbon in the package and eventually leads to higher surface area to improve the adsorption performance and in turn reduce the dust spillage of the activated carbon from the package.

The activated carbon beads of the present invention are packaged in a pervious canister or a sachet.

Now a preferred process for preparing the activated carbon beads is disclosed. The process for preparing the activated carbon beads includes the steps of:
(a) preparing activated carbon from coconut shells;
(b) treating the carbon with polymer;
(c) preparing beads of the carbon by precipitation, fluidized bed granulation or rotary granulation;
(d) activating the carbon beads through drying, heating and/or calcination to remove the added biopolymer partially/completely;
(e) rotational agitation of beads to separate any dust spillage followed by sieving the beads to obtain beads of desired sizes, specifically sizing 0.3-2 mm; and
(f) packaging the beads into pervious canisters or pouches.

The polymers used for treating the carbon are selected from Natural polymers or Synthetic polymers. The synthetic polymers are selected from polymers based on vinyl, acrylic or methacrylic acids. The natural polymers are further selected from biopolymers, protein polymers or synthetic biodegradable polymers. The natural polymers are specifically biopolymers, namely, cellulose, chitosan and alginates. The polysaccharides and protein-based polymers are obtained from natural sources. The synthetic biodegradable polymers are selected from polyesters or copolyesters of lactic acid and glycolic acid, polycaprolactone, polyanhydrides, and polyethylene glycol.

The activated carbon beads are packaged in pervious canisters or sachets to adsorb contaminant gases emitting through food, pharmaceutical and nutraceutical products.

In another embodiment, the activated carbon beads are combined with other desiccants or adsorbents. The other desiccants that are combined with activated carbon beads are selected from silica gel or molecular sieve beads. The combination proportions are selected from proportions of 1 part by 3 part, or 1 part by 1 part, or 2 part by 1 part, or 3 part by 1 part, or 3 part by 2 part of activated carbon beads. Such combinations impart both gas and water adsorption properties to the desiccants.

In yet another embodiment, the activated carbon tablet composition includes the following components:
1. 50 to 80 g of Activated carbon powder
2. 10 to 40 g of Attapulgite clay
3. 5.5 to 10 g of a binder and
4. 0.75 to 2 g of a lubricant

In accordance with this embodiment, the activated carbon powder and attapulgite clay are present in a ratio selected from 70:20, 60:30, 40:50 and the like.

The binder is polyvinyl alcohol (PVA) and the lubricant is magnesium stearate. The presence of attapulgite clay provides dual advantage of serving as binding agent and moisture absorber.

The activated carbon tablets of the present invention are packaged in a blister filter case, filter pouch and/or perforated canisters.

Now a preferred process for preparing the activated carbon tablets is disclosed. The process for preparing the activated carbon tablets includes the steps of:
(a) adding attapulgite clay to the activated carbon powder in a predefined ratio;
(b) adding the lubricant to the mixture of step (a);
(c) dissolving binder in water by heating at a predefined temperature for a predefined period of time;
(d) adding binder to the mixture formed in step (b);
(e) preparing a slurry of the mixture of step (b) by adding water;
(f) drying the slurry at a predefined temperature for a predefined period of time;
(g) grinding the dried mixture to obtain powder followed by sieving and
(h) making the tablets from the powder obtained in step (g) using a tablet press machine.

The activated carbon powder and attapulgite clay are present in a ratio of 70:20. 10 g of the binder PVA granules is dissolved in 100 ml water by heating at predefined temperature of 80° C. till complete dissolution and cooled for 20 minutes. The PVA solution is mixed with the required ratio mixture of activated carbon and attapulgite clay with additional 140-160 ml deionized water to prepare a homogeneous slurry. The slurry is dried at 110° C. for 3-4 hours to keep around 12-20% of moisture in dried mixture. The tablets prepared from the above process are further evaluated for their properties towards odor and moisture removal.

In a further embodiment, the activated carbon tablets include other desiccants or adsorbents. The other desiccant that is included in the activated carbon tablet is selected from silica gel, molecular sieves 4A, molecular sieves 5A, molecular sieves 3A and molecular sieves 13X. These combinations impart both gas and water adsorption properties to the tablet.

These and other embodiments will be apparent to those of skill in the art and others in view of the following detailed description of some embodiments. It should be understood, however, that this summary, and the detailed description illustrate only some examples of various embodiments, and are not intended to be limiting to the invention as claimed.

### EXAMPLES

Only a few examples and implementations are disclosed. Variations, modifications, and enhancements to the described examples and implementations and other implementations can be made based on what is disclosed.

Examples are set forth herein below and are illustrative of different amounts and types of reactants and reaction conditions that can be utilized in practicing the disclosure. It will be apparent, however, that the disclosure can be practiced with other amounts and types of reactants and reaction conditions than those used in the examples, and the resulting devices various different properties and uses in accordance with the disclosure above and as pointed out hereinafter.

### Example 1: Test Parameters to Use Activated Carbon Tablets for Odor Removal Application

| Sr No. | Test Parameters | Specification |
|---|---|---|
| 1 | Appearance | Black Color Tablets |
| 2 | Visual Inspection | Black color tablets should |
| | | be free from foreign |
| | | particles |
| 3 | Weight | 0.500 g ± 0.1 g |
| 4 | Dimensions | Diameter: 11.0 mm ± 2.0 mm |
| | | Height: 6.00 ± 2.0 mm |
| 5 | Loss On Drying (% By | NMT 5% |
| | Weight) @ 120° C. | |
| 6 | Chloride Content | Turbidity of the sample |
| | | solution should not be |
| | | darker than the |
| | | reference standard solution |
| 7 | Sulphate Content | Turbidity of the sample |
| | | solution should not be |
| | | darker than the reference |
| | | standard solution |
| 8 | Un-Carbonized | Filtrate is colorless |
| | Constituents | |
| 9 | Iodine Value | NLT 600 mg/g |
| 10 | Butane Activity | NLT 12% |

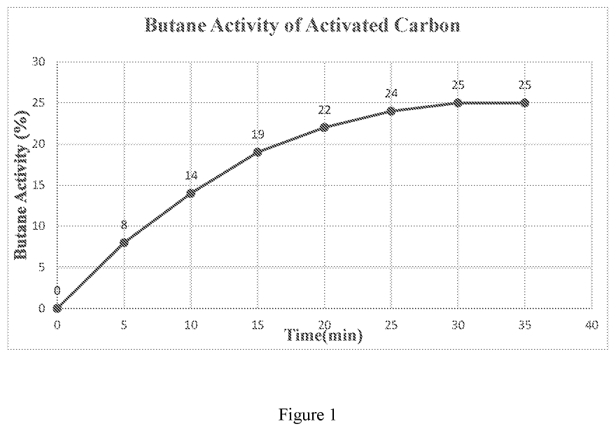

The activated carbon tablets comply with the above requirements towards use for odor adsorption as done conventionally with activated carbon granules. The uniform butane adsorption isotherm as indicated in FIG. 1 suggests uniform porosity in the activated carbon tablets.

### Example 2: Composition of Activated Carbon Tablet

| Sr No. | Components | % | Actual weight taken in g |
|---|---|---|---|
| 1 | Activated Carbon | 62.50 | 70 |
| 2 | Attapulgite | 26.79 | 30 |
| 3 | PVA | 8.93 | 10 |
| 4 | Magnesium Stearate | 1.80 | 2 |

### Example 3: Composition of Activated Carbon & Silica Gel Tablet

| Sr No. | Mixture Composition | % | Actual weight taken in g |
|---|---|---|---|
| 1 | Carbon | 31.25 | 35 |
| 2 | Silica Gel | 31.25 | 35 |
| 3 | Attapulgite | 26.79 | 30 |
| 4 | PVA | 8.93 | 10 |
| 5 | Magnesium Stearate | 1.79 | 2 |

### Example 4: Test Parameters of Activated Carbon & Silica Gel Tablet for Odor Removal as Well as Moisture Adsorption Application

| Sr No. | Test Parameters | Results |
|---|---|---|
| 1 | Appearance | Dark grey color tablets |
| 2 | Visual Inspection | Dark grey color tablets should |
| | | be free from foreign particles |
| 3 | Weight | 0.383 g |
| 4 | Dimensions | Diameter: 11.465 mm |
| | | Height: 4.726 mm |
| 5 | Loss On Drying (% By | 2.80% |
| | Weight) @ 145° C. | |
| 6 | Chloride Content | Turbidity of the sample solution |
| | | is not darker than the |
| | | reference standard solution |
| 7 | Sulphate Content | Turbidity of the sample solution |
| | | is not darker than the |
| | | reference standard solution |
| 8 | Un-Carbonized | Filtrate is colorless |
| | Constituents | |
| 9 | Iodine Value | 594 mg/g |
| 10 | Butane Activity | 10.03% |
| 11 | Moisture Adsorption | 18.03% |
| | Capacity @ 25° C., 80% | |
| | RH | |

The prepared tablets comply with the above requirements towards use for odor removal as well as moisture adsorption as done conventionally with combination of activated carbon granules and silica gel.

### Example 5: Preparation of Activated Carbon Tablet

1. Dissolve 10 g of PVA in 100 ml water till dissolution under heating at 80-degree C. Keep it for cooling for 20 minutes.

2. Prepare a homogeneous mixture of 70 g activated carbon fine powder, 30 g of attapulgite clay and 2 g of magnesium stearate.

3. Add 10 gm of dissolved and cooled PVA in the above mixture along with 200 ml of deionized water to obtain a homogeneous slurry.

4. Dry the slurry in a vacuum oven to ensure the moisture content is between 12-20% post drying of above slurry.

5. Grind the dried mixture to obtain powder that is further sieved through 18 mesh sieving devices.

6. Make tablets with the above mixture with the pressure set between 15-25 Kn with tablet press machine.

### Example 6: Preparation of Activated Carbon and Silica Gel Tablet

1. Dissolve 10 g of PVA in 100 ml water till dissolution under heating at 80° C. Keep it for cooling for 20 minutes.

2. Prepare a homogeneous mixture of 35 g activated carbon fine powder, 35 g silica gel, 30 g of attapulgite clay and 2 g of magnesium stearate.

3. Add 10 gm of dissolved and cooled PVA in the above mixture along with 200 ml of deionized water to obtain a homogeneous slurry.

4. Dry the slurry under following heating scheme in a Vacuum oven to ensure the moisture content of about 20% post drying of above slurry.

5. Grind the dried mixture to obtain powder that is further sieved through 18 mesh sieving devices.

6. Make tablets with the above mixture with the pressure set between 15-25 Kn with tablet press machine.

### Example 7: Preparation of Activated Carbon Beads

### Example 7a

500 g of activated carbon powder having particle size between 100 to 200 mesh is mixed with 200 g of sodium alginate (SA) and dissolved in 2000 ml of distilled water through constant stirring with industrial Stirrer, at 500 RPM for 35 minutes. 200 g of zinc chloride and 50 g of calcium chloride is dissolved in 500 ml of distilled water through constant stirring with industrial stirrer, at 400 RPM for 20 minutes. The AC-SA solution is filled into a glass column fitted in vertical position with zinc chloride and calcium chloride solution at the base to perform the precipitation of AC-SA beads.

The zinc chloride and calcium chloride solution is kept for stirring throughout the precipitation. The precipitated beads are removed with the help of nylon sieves and spread over drying tray kept at 110° C. The dried beads are removed after 1 hr and hermetically sealed into PE bags for use.

MAC results:
At 40% RH, 25° C.: 6%
At 80% RH, 25° C.: 16.4%
LOI: 0.89%
Iodine value: 746 mg/g
Butane activity: 14%
Bulk density: 0.57 g/ml
Attrition rate: 0.65%

### Example 7b

25 kg of sodium alginate is dissolved in 100 liters of distilled water with constant stirring at 500 rpm in an in-house fabricated industrial stirrer. The stirring was continued for 2 hours with intermittent addition of 45 kg of powdered activated carbon. A homogeneous gel was obtained that was then transferred to glass columns having narrow openings required for desired beads size. The black gel was allowed to drop in to 500 liters of 20% Calcium chloride solution kept at room temperature with slow stirring to facilitate beads formation and avoiding agglomeration of formed beads. The precipitating solution was optionally added with 1 kg of boric acid to incorporate antimicrobial properties in the precipitated beads. The beads thus formed were removed from the calcium chloride solution and spread over a tray drier with oven temperature set at 120° C. for 6 hours.

The oven dried beads were removed from the trey drier and kept in moisture barrier bags for further processing or evaluations.
MAC results: At 40% RH, 25° C.: 3%
At 80% RH, 25° C.: 17%
LOI: 2.1%
Iodine value: 800 mg/g
Butane activity: 13%
Bulk density: 0.51 g/ml
Attrition rate: 0.64%

### Example 7c

500 g of activated carbon powder having particle size between 100 to 200 mesh is mixed with 200 g of sodium alginate (SA) and dissolved in 2000 ml of distilled water through constant stirring with industrial stirrer, at 500 RPM for 35 minutes. 200 g of chitosan and 50 g of Zinc chloride is dissolved in 500 ml of 2% acetic acid solution through constant stirring with industrial stirrer, at 400 RPM for 45 minutes. The AC-SA solution is filled into a glass column fitted in vertical position with zinc chloride-chitosan solution at the base to perform the precipitation of AC-SA beads. The zinc chloride-chitosan solution is kept for stirring throughout the precipitation. The precipitated beads are removed with the help of nylon sieves and spread over drying tray kept at 110° C. The dried beads are removed after 6 hr and hermetically sealed into PE bags for use.

MAC results:
At 40% RH, 25° C.: 1.25%
At 80% RH, 25° C.: 11%
LOI: 0.4%
Iodine value: 745 mg/g
Butane activity: 12.3%
Bulk density: 0.48 g/ml
Attrition rate: 0.91%

### Example 7d

25 kg of chitosan flakes is dissolved in 100 liters of 3% acetic acid solution with constant stirring at 2000 rpm in an in-house fabricated industrial stirrer. The stirring was continued for 4 hours with intermittent addition of 83 kg of powdered activated carbon. A homogeneous thick gel was obtained that was then transferred to glass columns having narrow openings required for desired beads size. The black gel was allowed to drop in to 500 liters of 25% sodium hydroxide solution kept at room temperature with slow stirring to facilitate beads formation and avoiding agglomeration of formed beads. The precipitating solution was optionally added with 1 kg of boric acid to incorporate antimicrobial properties in the precipitated beads. The beads thus formed were removed from the sodium hydroxide solution and spread over a tray drier with oven temperature set at 140° C. for 8 hours.

The oven dried beads were removed from the trey drier and kept in moisture barrier bags for further processing or evaluations.
MAC results: At 40% RH, 25° C.: 6%
At 80% RH, 25° C.: 15%
LOI: 1.1%
Iodine value: 912 mg/g
Butane activity: 12.5%
Bulk density: 0.49 g/ml
Attrition rate: 0.75%

### Example 7e

500 g of activated carbon powder having particle size between 100 to 200 mesh is mixed with 200 g of Chitosan and dissolved in 2000 ml of 2% acetic acid solution through constant stirring with industrial stirrer, at 500 RPM for 90 minutes. 500 ml of 25% Liquid ammonia solution is prepared through constant stirring with industrial Stirrer, at 400 RPM for 20 minutes. The AC-Chitosan solution is filled into a glass column fitted in vertical position with ammonia solution at the base to perform the precipitation of AC-chitosan beads. The ammonia solution is kept for stirring throughout the precipitation. The precipitated beads are removed with the help of nylon sieves and spread over drying tray kept at 90° C. The dried beads are removed after 5 las and hermetically sealed into PE bags for use.

MAC results:
At 40% RH, 25° C.: 3.5%
At 80% RH, 25° C.: 13.25%
LOI: 1.2%
Iodine value: 645 mg/g
Butane activity: 10.9%
Bulk density: 0.48 g/ml
Attrition rate: 0.53%

### Example 7f

5 kg of Polyvinyl acetate (PVA) is dissolved in 100 liters of distilled water at 90° C., with constant stirring at 500 rpm in an in-house fabricated industrial stirrer. The stirring was continued for 2 hours with intermittent addition of 8.6 kg of powdered activated carbon. A homogeneous gel was obtained that was then transferred to glass columns having narrow openings required for desired beads size. The black gel was allowed to drop in to 500 liters of 40% sodium hydroxide solution kept at room temperature with slow stirring to facilitate beads formation and avoiding agglomeration of formed beads. The precipitating solution was optionally added with 1 kg of boric acid to incorporate antimicrobial properties in the precipitated beads. The beads thus formed were removed from the sodium hydroxide solution and spread over a tray drier with oven temperature set at 120° C. for 6 hours.

The oven dried beads were removed from the trey drier and kept in moisture barrier bags for further processing or evaluations.
MAC results: At 40% RH, 25° C.: 5%
At 80% RH, 25° C.: 15%
LOI: 1.2%
Iodine value: 675 mg/g
Butane activity: 15.4%
Bulk density: 0.5 g/ml
Attrition rate: 0.56%

### Example 8: Characterization of Activated Carbon Tablets

1) The water stability of activated carbon (A/C) and activated carbon+silica gel (A/C+SG) is calculated by adding 10 g of dried tablets in 100 ml of deionized water at room temperature for 15 minutes. The dried weight difference of tablets provided the water stability more than 97% for A/C tablets and more than 94% for (A/C+SG) tablets.

2) The crush strength for A/C tablet is of 2.2 to 3.4 kg/tablet and 2.0 to 3.1 kg/tablet for (A/C+SG) tablet.

3) The abrasion hardness of 88-98 was observed for A/C tablet and 78-89 for (A/C+SG) tablet, as per the standard ASTM 3802-79 method.

4) The change in pH of activated carbon powder to tablet is observed. The pH changes from 5.1 to 4.7.

5) The dust attrition rate is less than 0.1 mg/dl/min for activated carbon and less than 0.4 mg/dl/min for A/C+SG tablets.

6) The lower ash content of A/C tablets is 3% and for (A/C+SG) tablets is 3.2%.

### Example 9: Physical Characteristics of Activated Carbon Beads

| | Granular | A/C- | A/C- | A/C + SG | | |
|---|---|---|---|---|---|---|
| | activated | synthetic | Bio- | Bio- | Activated | Activated |
| | carbon | polymer | polymer | polymer | carbon | carbon + |
| Characteristics | (Reference) | beads | beads | beads | tablet | SG tablet |
| Moisture | 16% | 13.45% | 14.3% | 20.9% | 17.2% | 21% |
| adsorption | | | | | | |
| capacity (wt %) | | | | | | |
| Loss on | 2.35% | 0.7% | 1.2% | — | 1.25% | — |
| ignition (LOI) | | | | | | |
| % | | | | | | |
| Butane activity | 20.6% | 12.5% | 14% | 12.3% | 14.5% | 12.3% |
| (%) | | | | | | |
| Iodine value | 1005 mg/g | 715 mg/g | 740/g | 640 mg/g | 891 mg/g | 375 mg/g |
| (mg/g) | | | | | | |

Advantageously, the activated carbon beads of the present invention have less powder spillage from packages due to their extensive fill density, high surface area and high wear resistance capacity. The activated carbon beads of the present invention packed in canisters and sachets are useful for adsorbing contaminant gases emitting through food, pharmaceutical and nutraceutical products. The activated carbon tablets of the present invention have reduced dust spillage, high abrasive strength, surface area and adsorption capacity. The activated carbon tablets of the present invention possess high mechanical strength that restricts powder formation. The activated carbon tablets of the present invention packed in blister filter case, pouch or canisters are useful for adsorbing contaminant gases emitting through food, pharmaceutical and nutraceutical products. The activated carbon tablets of the present invention are capable of simultaneous adsorption of moisture and odor/gas from pharmaceutical and nutraceutical product packages.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the spirit or scope of the present invention.

1. A shaped activated carbon in the form of spherical beads having a diameter in range of 0.3-2 mm wherein the activated carbon beads have extensive fill density, high surface area and high wear resistance capacity leading to reduced dust spillage.

2. A process for preparation of the activated carbon beads as claimed in claim 1 wherein the steps are as follows:
(a) preparing activated carbon from coconut shells;
(b) treating the carbon with polymer;
(c) preparing beads of the carbon by precipitation, fluidized bed granulation or rotary granulation;
(d) activating the carbon beads through drying, heating and/or calcination to remove the added biopolymer partially/completely;
(e) rotational agitation of beads to separate any dust spillage followed by sieving the beads to obtain beads of desired sizes, specifically sizing 0.3-2 mm; and
(f) packaging the beads into pervious canisters or pouches.

3. The process as claimed in claim 2 wherein the polymers used for treating the carbon are selected from natural polymers selected from biopolymers, protein polymers or synthetic biodegradable polymers or synthetic polymers selected from polymers based on vinyl, acrylic or methacrylie acids.

4. An activated carbon tablet composition comprising:
a) 50 to 80 g of Activated carbon powder;
b) 10 to 40 g of Attapulgite clay;
c) 5.5 to 10 g of a binder, and
d) 0.75 to 2 g of a lubricant.

5. The tablet composition as claimed in claim 4, wherein the composition includes an additional desiccant selected from silica gel, molecular sieves 4A, molecular sieves 5A, molecular sieves 3A and molecular sieves 13X.

6. The tablet composition as claimed in claim 4, wherein the binder is polyvinyl alcohol and the lubricant is magnesium stearate.

7. A process for preparing the activated carbon tablets as claimed in claim 4 includes the steps of:
(a) adding attapulgite clay to the activated carbon powder in a ratio of 70:20;
(b) adding the lubricant to the mixture of step (a);
(c) dissolving binder in water by heating 80° C. for 20 minutes;
(d) adding binder to the mixture formed in step (b);
(e) preparing a slurry of the mixture of step (b) by adding water;
(f) drying the slurry at 110° C. for 3-4 hours;
(g) grinding the dried mixture to obtain powder followed by sieving and
(h) making the tablets from the powder obtained in step (g) using a tablet press machine.
